(19) United States
(12) Patent Application Publication
(10) Pub. No.: US 2026/0227245 A1
(43) Pub. Date: Aug. 6, 2026

(54) THERMAL SENSOR FOR USE WITH A BATTERY MODULE

(71) Applicant: Lithos Energy, Inc., Hayward, CA (US)

(72) Inventors: Robert Wayne Sweney, Oakland, CA (US); Dennis Lauguico, Burnaby (CA); Nilesh Ashok Kharat, Fremont, CA (US)

(21) Appl. No.: 19/047,023

(22) Filed: Feb. 6, 2025

(51) Int. Cl. G01K 1/14; G01K 1/02; H01M 10/42; H01M 10/48; H01M 50/213

(52) U.S. Cl. CPC G01K 1/14; G01K 1/026; H01M 10/425; H01M 10/482; H01M 10/486; H01M 50/213; H01M 2010/4271

(57) ABSTRACT

A thermal sensor in a battery module is disclosed. The thermal sensor comprises a clip into which a thermal sensor is placed, which clip holds the thermal sensor against a battery cell; at least two battery module frame blocks, comprising individual battery cell frames connected together; and a space between the at least two battery module frame blocks into which the clip holding the thermal sensor is placed. The disclosure further provides a system for monitoring temperature in a battery module. The system comprises at least two frame blocks, a space in an interface between the at least two frame blocks, and a thermal sensor. A clip is positioned in the space between the battery module frame blocks. The clip is also configured to hold the thermal sensor against a battery cell. The thermal sensor monitors the temperature of the battery cell against which the thermal sensor is placed.

### TECHNICAL FIELD

This disclosure relates to battery modules and specifically to monitoring temperature of battery cells in battery modules.

### BACKGROUND

Lithium based batteries achieve their maximum electrical performance and durability within a limited temperature range. This temperature range is generally between 20° C. and 30° C. As temperatures rise above 30° C., the cell oxidation rate increases, which causes faster degradation of the battery, decline in performance, and reduced capacity of the battery. Lithium batteries operated at temperatures over 40° C. may lead to permanent battery damage. Maintaining the temperature of the battery between 20° C. and 30° C. increases the efficiency, life, and safety of the battery.

### SUMMARY

In a first aspect, the disclosure provides a thermal sensor in a battery module. The thermal sensor comprises a clip into which a thermal sensor is placed, which clip holds the thermal sensor against a battery cell; at least two battery module frame blocks, comprising individual battery cell frames connected together; and a space between the at least two battery module frame blocks into which the clip holding the thermal sensor is placed.

In a second aspect, the disclosure provides a system for monitoring temperature in a battery module. The system comprises at least two battery module frame blocks, a space in an interface between the at least two battery module frame blocks, and a thermal sensor. The battery module frame blocks comprise individual battery cell frames connected together. The individual battery cell frames each hold a battery cell. The at least one thermal sensor is placed in at least one clip. The clip is positioned in the space between the battery module frame blocks. The clip is also configured to hold the thermal sensor against a battery cell. The thermal sensor monitors the temperature of the battery cell against which the thermal sensor is placed.

In a third aspect, the disclosure provides a method for monitoring temperature in the battery module. The method comprises placing at least one thermal sensor in a space at an interface of two battery module frame blocks and monitoring the temperature of the battery cell. The battery module frame blocks comprise individual battery cell frames connected together. The at least one thermal sensor may be positioned adjacent to a battery cell held in an individual battery cell frame of one of the battery module frames.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a top perspective view of a battery module.

FIG. 2 is a top-down view of battery module.

FIG. 3 is a side view with a partial cross section of the interface between two frame blocks of a battery module.

FIG. 4 is a view of the flexible printed circuit and attached thermal sensors isolated from surrounding structures.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

Thermal sensors detect temperature changes through various physical phenomena, such as resistance changes, voltage generation, or expansion of materials. As used herein, “thermal sensor” means a device that converts thermal energy (heat) into an electrical signal to measure temperature. Types of thermal sensors include thermocouples, thermistors, resistance temperature detectors, and semiconductor-based sensors. Thermocouples generate voltage at the junction of two dissimilar metals. Thermocouples operate on the principle of the Seebeck effect where a temperature difference between two dissimilar electrical conductors or semiconductors produces a voltage difference between the conductors or semiconductors. Resistance Temperature Detectors (RTDs) measure temperature through changes in electrical resistance. Semiconductors-based sensors utilize temperature-sensitive voltage-current characteristics of diodes. Thermistors are temperature sensitive resistors. Thermistors exhibit a significant and predictable change in electrical resistance in response to temperature variations. There are two main types of thermistors: Negative Temperature Coefficient (NTC), in which resistance decreases as temperature increases; and Positive Temperature Coefficient (PTC), in which resistance increases as temperature increases. Thermistors are typically made from semiconductor materials, often metal oxides such as cobalt, nickel, iron, copper, and manganese for NTC types, or barium, strontium, and lead titanates for PTC types. Thermistors are generally operable in a wide range of temperatures: commonly −55° C. to 200° C. for NTC types, and PTC types often having switching temperatures between 60° C. and 120° C. Thermistors may be highly accurate some models are able to achieve ±0.1° C. precision. Thermistors may also be responsive to allow for rapid detection of temperature changes, often responding in under one second.

As used herein, “battery” is meant to refer to a device that stores chemical energy and converts it into electrical energy. A battery is made up of one or more electrochemical cells that use chemical reactions to produce electricity.

Battery cells are grouped into modules for several reasons. One reason is to improve safety. By grouping the cells together, it is easier to contain any leakage of electrolyte. Additionally, any fire will be isolated into a smaller group. Further, modules can be equipped with sensors and controls that can help to prevent safety hazards. Another reason to group cells into modules is to improve efficiency. By connecting the cells in series, the voltage of the battery pack can be increased. By connecting the cells in parallel, the capacity of the battery pack can be increased. This allows battery packs to be tailored to the specific of an application. Grouping cells into modules can make them easier to manufacture and assemble. Modules can be pre-assembled and tested before being integrated into a larger battery pack. This can help to improve the quality and reliability of battery packs.

Battery cells are often cylindrical in shape. Cylindrical shapes for battery cells offer some advantages including good mechanical stability and ease of manufacture. The cylindrical shape distributes pressure evenly throughout the cell. This makes them structurally strong and able to withstand the buildup of internal pressure during operation. This is important for safety, as it reduces the risk of leaks or ruptures. Cylindrical cells are relatively simple to manufacture using automated processes. This makes them a cost-effective option, especially for mass production. The winding process for the electrodes within the cell is well-established and allows for consistent quality. The cylindrical shape allows for better air circulation around the cell, which helps to keep it cool. This is important because heat can degrade battery performance and lifespan. Cylindrical cells can better handle swelling caused by gas buildup during charging and discharging cycles.

However, disadvantages of cylinders include the necessity to provide a frame to hold the cylinders because a cylinder is less stable when positioned on one end. The electrodes are generally positioned at the top of the battery cell. Connections between the electrodes are therefore at the top of the of each battery cell. Movement at the top of the battery cells can lead to broken electrical connections. Many battery pack designs, particularly those designed for cylindrical battery cells utilize adhesives or mechanical retention devices which are located away from the top of the battery cell. Adhesives are heavy, expensive, hard to control, and often have a slow cure time. All these detriments to adhesives affect the speed at which a battery pack is assembled. Mechanical retention away from the top of the cell, offers less mechanical rigidity to the top of the cell, which is detrimental because many of the electrical connections attach at the top of the cell, where the electrodes are positioned, if the battery cells are not held rigidly in place connections between the cells can be difficult to establish, or can be broken if the cells shift.

A frame can be used to hold the battery cells in place. Each battery cell requires its own frame, a battery cell holding frame. Each battery cell holding frame is constructed of a rigid top integrated with an enclosure which surrounds a cavity into which a battery cell fits. In some implementations, the enclosure is cylindrical. In some implementations, the enclosure includes multiple walls, the multiple walls include any number of walls. In some implementations, the frame has between three and ten side walls. In some of these implementations, the side walls are of equal lengths on the horizontal axis, creating regular shapes or regular polygons. In some implementations, the side walls are of different lengths on the horizontal axis. In some implementations, the frame may extend the full length of the battery cell. In some other implementations, the frame may be in two portions, an upper portion which encompasses and supports the top of a battery cell and a lower portion which encompasses and supports the bottom of the battery cell. In these implementations, the upper portion may be between one fourth the length of the battery cell and one half the length of the battery cell. In other implementations, the upper portion may be one third the length of the battery cells.

In some implementations, the battery cell holding frames are arranged in rows. In some implementations, the battery cell holding frames are arranged in rows of between three and sixteen battery cell holding frames. In some implementations, the rows are further arranged into multiple rows to create a frame block. In some implementations, the frame blocks are arranged between three rows and sixteen rows. In some implementations, a frame block may be arranged from three rows of three frames to twelve rows of twelve frames. In some implementations, a frame block is arranged in eight rows of twelve battery cell holding frames. In some implementations, the frame blocks are further arranged into modular battery frames. In some implementations, the modular battery frame is constructed of multiple frame blocks. Any number of battery frame blocks may be combined to create modular battery frames of any size.

Each modular battery frame is constructed of frame blocks attached to scaffolds. Each frame block is further constructed of several components. The modular battery frames are constructed around battery cells. The frame blocks are constructed of battery cell frames connected together to hold any desired number of battery cells 115. In some implementations, the frame blocks are designed with between two (2) and two-hundred and fifty-six (256) battery cell holding frames. The battery cells are connected together by collectors. Each battery cell connects to the collectors, and the collectors aggregate the battery cells. The manner in which the battery cells are aggregated along with the number of battery cells in the modular battery frame determines the capacity and voltage of the battery module. For battery modules containing a specific number of battery cells, aggregating the battery cells in parallel will increase the capacity of the battery module, while aggregating the battery cells in series will increase the voltage of the battery module. In some implementations, the battery cells are aggregated in one manner for a smaller subset of the battery cells and then that smaller subset of battery cells is aggregated in a different manner. For example, a row of battery cells is aggregated in parallel, and then each row is aggregated in series. The resultant frame blocks could then be aggregated in series or in parallel. The frame blocks of the modular battery frames can be constructed in myriad options. Then the frame blocks are connectable in myriad options. Each modular battery frame is then connectable to other modular battery frames in myriad options. Thus, the options for creating a battery pack are multitudinous. The modularity of the modular battery frames enables the modular battery frame to be constructed to any desired specifications. This means that the modular battery frame is capable of being designed and configured to fit in places where other batteries or battery packs could not fit.

The addition of a cooling plate may increase the efficiency of a battery module. A cooling plate generally attaches to a single surface of a battery module. A cooling plate may assist in regulating the temperature of the individual battery cells in a battery module. By assisting in regulating the temperature of the battery cells, the battery cells are able to operate within more efficient temperature parameters.

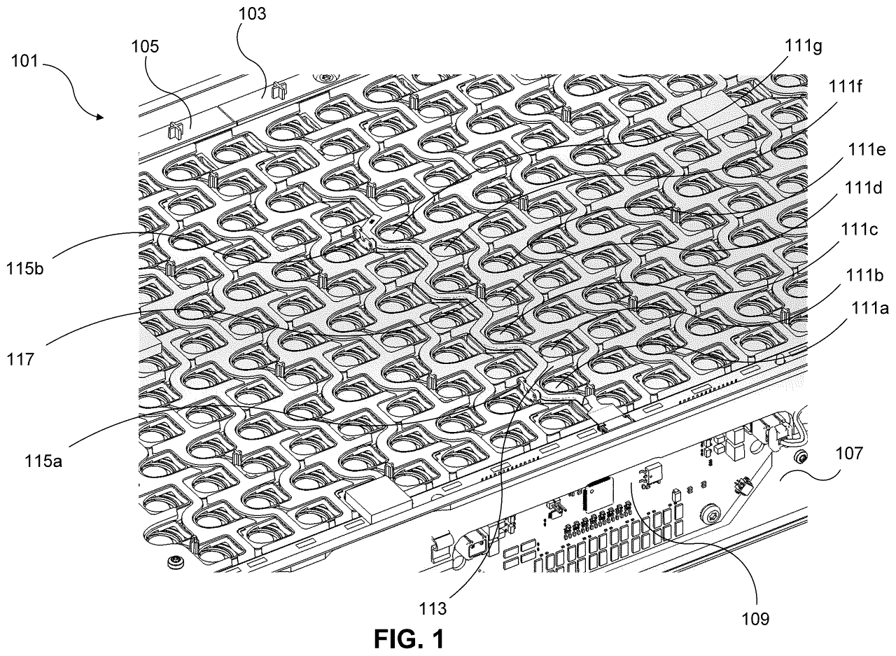

Now referring to FIG. 1, which is a top perspective view of a battery module. A battery module may include a system for monitoring the temperature of the battery module by monitoring the temperature of individual cells. The battery module 101 may include frame blocks 103 and 105. Each frame block includes battery cell frames connected together. Frame blocks 103 and 105 are attached to a scaffold 107. Also attached to the scaffold 107 is a battery management system (BMS) 109. A space exists at the interface between frame blocks. This space is a narrow gap which is accessible from the top of the module. Into this gap, clips 115a and 115b, configured to hold thermal sensors, may be positioned. The individual battery cells, such as battery cells 111a, 111b, 111c, 111d, 111e, 111f, and 111g are connected together by collectors such as collector 113. The clips hold the thermal sensors in contact with battery cell bodies. The thermal sensors are also connected to the BMS 109. The thermal sensors are designed to be electrically isolated from the voltage of the cells. The thermal sensors may be connected to the BMS 109 by a circuit, the circuit may be a flexible printed circuit 117. The thermal sensors are located on the arms of the flexible printed circuit 117. The flexible printed circuit 117 connects to the BMS 109 and the thermal sensors are held in place by the clips 115a and 115b between the frame blocks. The placement of the thermal sensors in the gap between the frame blocks allows for temperature measurement and monitoring at the core or center of the battery module 101. Multiple clips such as clips 115a and 115b hold multiple thermal sensors against multiple battery cells such as battery cells 111a and 111g. The placement also enables a distributed monitoring of sensors throughout a battery module, such that multiple locations are monitored to give a more complete indication of the temperature of the battery module. By placing the sensors in the interior of a battery module, the thermal sensors are well protected from damage. Additional thermal sensors may be placed in other locations of the battery module, such as around the periphery of the frame blocks.

In some implementations the battery module includes a cooling plate. A cooling plate may assist in maintaining a temperature at which the battery cells in the battery module function more effectively. In some of these implementations, the thermal sensors transmit the temperature readings to the BMS 109. The BMS 109 may include a processor with instructions to activate the cooling plate when the temperature of the battery cells recorded by the thermal sensor is above a certain temperature. The temperature at which a cooling plate may be activated may depend upon the operating instructions of the battery module contained in the processor of the BMS 109. In some implementations, the BMS 109 may communicate with a user, and the user will activate the cooling plate. In some implementations, the BMS is passive at reports the temperature to a user, through a user's device. In other implementations, the BMS is programmed to activate a cooling plate when certain conditions are met.

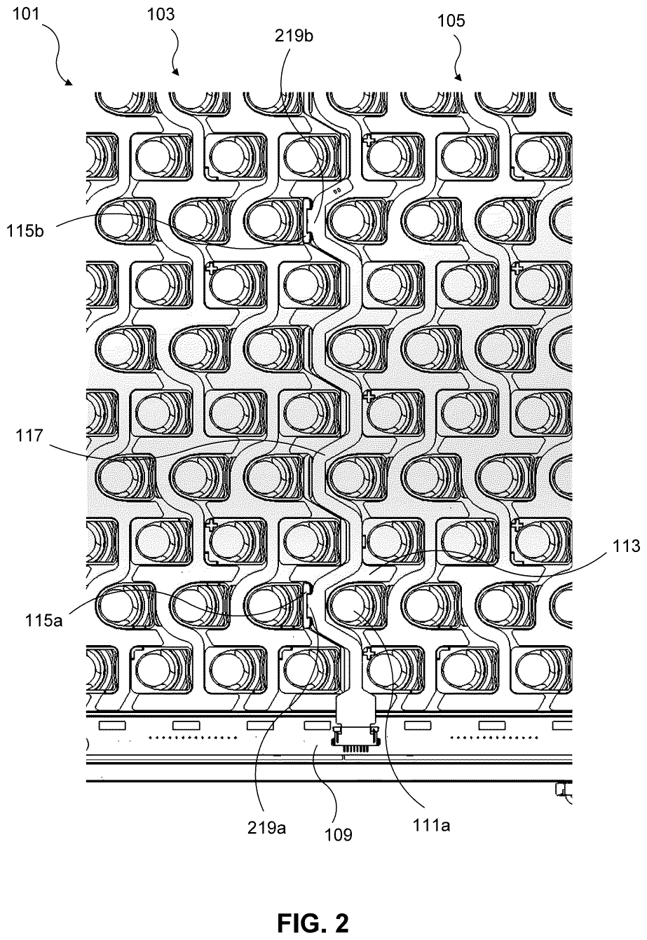

Referring now to FIG. 2 which is a top-down view of battery module 101. The battery cells are held in individual battery cell frames and the battery cell frames are connected to form frame blocks such as frame blocks 103 and 105. The frame blocks 103 and 105 are then connected by a scaffold. At the interface of the frame blocks 105 and 105 is a gap (covered by collector 113 and flexible printed circuit 117). The collectors such as collector 113 and the flexible printed circuit 117 are compatible with troughs in the top of the frame blocks. These troughs are designed to keep the collectors and the flexible printed circuit in place, to minimize the chance of damage to the collector or to the flexible printed circuit. Connectors such as collector 113 aggregate the individual battery cells. The connectors may aggregate the battery cells in parallel or in series depending on the requirements of the battery module. Into the gap between frame blocks 103 and 105, clips 115a and 115b are inserted. The clips 115a and 115b retain thermal sensors and preload them against battery cells. The thermal sensors are located on arms 219a and 219b of the flexible printed circuit. The flexible printed circuit connects to the BMS 109. The BMS monitors the functions of the battery module including temperature, discharge rate, current, voltage, recharge rate, and other characteristics of the battery module.

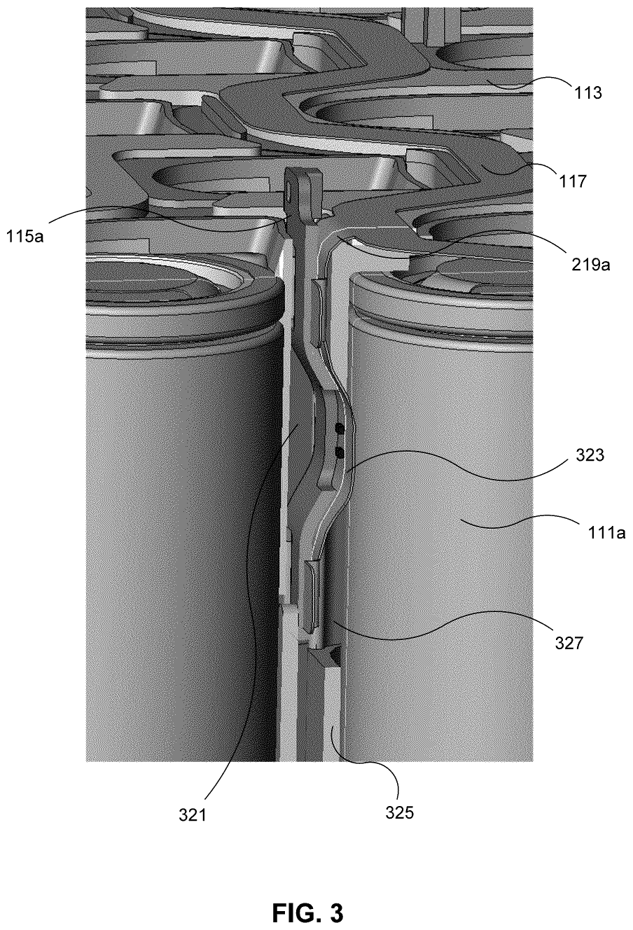

Referring now to FIG. 3 which is a side view with a partial cross section, the clip 115a is seen inserted into the gap 321 between frame blocks 103 and 105. The thermal sensor 323 connects to the flexible printed circuit 117 by arm 219a. The clip 115a is configured to press the thermal sensor against the body of battery cell 111a. The battery cell frame 325 into which battery cell 111a is placed, is configured with a window 327. The window is located in a side of the battery cell frame facing the gap at the interface between frame blocks. The thermal sensor 323 passes through this window 327 to connect to the battery cell 111a. The clips 115a is configured to press the thermal sensor against the body of the battery cell. The clips should be manufactured from a material that provides the bias to press the thermal sensor against the battery cells. The clips need to be constructed of a material that can be manufactured to press the thermal sensor against the battery cell. The clip should also be constructed of a non-conducting material, to ensure that the temperature being measured is not affected by the materials around the sensor. In some implementations, a single individual battery cell frame, adjacent to the space at the interface of the frame blocks 103 and 105, includes a window 327 through which the thermal sensor connects to a battery cell. In some implementations, multiple battery cell frames, adjacent to the space at the interface of the battery cell frame blocks, include windows through which the thermal sensor connects to battery cells. Thus, multiple windows in the walls of multiple battery cell frames enable access to multiple battery cells. The thermal sensor 323a may be in direct contact with the battery cell 111a. Thus, the temperature sensor is closely coupled to the body of the battery cell to be measured. As the temperature of battery cell 111a changes, the resistance or voltage of the sensor changes. The change in temperature is sent to the BMS 109. The BMS may be collecting temperature data from multiple thermal sensors. The BMS 109 may identify the changes in temperature and pass that information on to a device operated by a user. The user may then take action including disconnecting the battery module from a power source or from a powered device, turning off the battery module, taking no action, or decreasing the current or voltage drawn from the battery module. The BMS may be programmed to autonomously take action at certain points. For example, the BMS may turn off or disconnect the battery module from a charging device or from a device drawing power if the temperature of the battery module reaches an upper limit, or a lower limit.

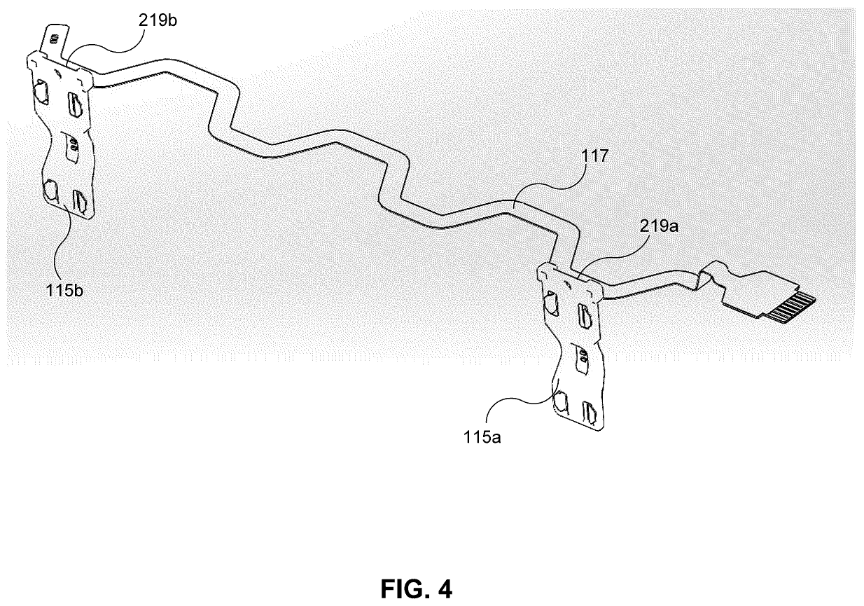

Referring to FIG. 4 which is a view of the flexible printed circuit 117 and attached thermal sensors isolated from surrounding structures. The flexible printed circuit is a ribbon circuit with arms 219a and 219b. The arms connected to the thermal sensors are secured in the clips 115a and 115b. The clips should not interfere with the sensors ability to measure electrical changes; therefore, the clips need to be manufactured from a substance that is not electrically conductive. Additionally, the clips need to be manufactured from materials that may be manufactured to press the thermal sensor against the body of battery cells. The material is able to flex for insertion into the space between the frame blocks, and maintain the thermal sensor pressed against the battery cell body. Such materials include polypropylene (PP), polyester (PET), polyimide (PI), carbon fiber reinforced polymer (CFRP), fiberglass reinforced polymer (FRP), and G-Flex EV.

The invention has been described with reference to various specific embodiments and techniques. Nevertheless, it is understood that many variations and modifications may be made while remaining within the spirit and scope of the invention.

What is claimed is:

1. A thermal sensor in a battery module comprising:
a clip into which a thermal sensor is placed, which clip holds the thermal sensor against a battery cell;
at least two battery module frame blocks, comprising individual battery cell frames connected together; and
a space between the at least two battery module frame blocks into which the clip holding the thermal sensor is placed.

2. The thermal sensor of claim 1, wherein at least one individual battery cell frame adjacent to the space between the battery module frame blocks includes a window to provide access to the battery cell.

3. The thermal sensor of claim 2, wherein the clip holding the thermal sensor fits within the window of the at least one individual battery cell frame.

4. The thermal sensor of claim 3, wherein the clip is configured to press the sensor against the battery cell held in the individual battery cell frame.

5. A system for monitoring temperature in a battery module, the system comprising:
at least two battery module frame blocks comprising individual battery cell frames connected together, the individual battery cell frames holding battery cells;
a space in an interface between the at least two battery module frame blocks; and
at least one clip into which at least one thermal sensor is placed, the clip being positioned in the space between the battery module frame blocks and configured to hold the thermal sensor against a battery cell; and
wherein the thermal sensor monitors the temperature of the battery cell against which the thermal sensor is placed.

6. The system for monitoring temperature in the battery module of claim 5, wherein at least one individual battery cell frame adjacent to the space between the battery module frame blocks includes a window to provide access to the battery cell held within the at least one individual battery cell frame.

7. The system for monitoring temperature in the battery module of claim 6, wherein the clip holding the thermal sensor fits within the window of the at least one individual battery cell frame.

8. The system for monitoring temperature in the battery module of claim 6, wherein multiple individual battery cell frames adjacent to the space between the battery module frame blocks each include a window to provide access to the battery cells held within each individual battery cell frame.

9. The system for monitoring temperature in the battery module of claim 8, wherein multiple clips holding multiple thermal sensors fit within multiple windows of the multiple individual battery cell frames.

10. The system for monitoring temperature in the battery module of claim 9, further comprising a flexible printed circuit to connect the multiple thermal sensors to a battery management system.

11. The system for monitoring temperature in the battery module of claim 10, wherein the flexible printed circuit comprises arms to which each thermal sensor is attached.

12. A method for monitoring temperature in a battery module comprising:
placing at least one thermal sensor in a space at an interface of two battery module frame blocks, the battery module frame blocks comprising individual battery cell frames connected together, the at least one thermal sensor being positioned adjacent to a battery cell held in an individual battery cell frame of one of the battery module frames; and
monitoring the temperature of the battery cell.

13. The method for monitoring temperature in the battery module according to claim 12, wherein at least one individual battery cell frame adjacent to the space between the battery module frame blocks includes a window to provide access to the battery cell held within the at least one individual battery cell frame.

14. The method for monitoring temperature in the battery module according to claim 13, wherein a clip holding the thermal sensor fits within the window of the individual battery cell frame.

15. The method for monitoring temperature in the battery module according to claim 14, wherein multiple individual battery cell frames adjacent to the space between the battery module frame blocks each include a window to provide access to the battery cells held within each individual battery cell frame.

16. The method for monitoring temperature in the battery module according to claim 15, wherein multiple clips holding multiple thermal sensors fit within the windows of multiple individual battery cell frames.

17. The method for monitoring temperature in the battery module according to claim 16, further comprising a flexible printed circuit to connect the multiple thermal sensors to a battery management system.

18. The method for monitoring temperature in the battery module according to claim 17, wherein the flexible printed circuit comprises arms to which each thermal sensor is attached.

19. The method for monitoring temperature in the battery module according to claim 17, wherein the multiple thermal sensors monitor the temperature of multiple battery cells to which each thermal sensor is adjacent.

20. The method for monitoring temperature in the battery module according to claim 19, wherein each sensor is positioned to enable temperatures to be monitored at a periphery and a core of the battery module.
